(19) United States
(12) Patent Application Publication
(10) Pub. No.: US 2024/0309851 A1
(43) Pub. Date: Sep. 19, 2024

(54) FLOATING WIND POWER GENERATION PLATFORM FOR OFFSHORE DEPLOYMENT

(71) Applicant: HISEAS ENERGY INC., Austin, TX (US)

(72) Inventor: William C. Alexander, Austin, TX (US)

(21) Appl. No.: 18/602,996

(22) Filed: Mar. 12, 2024

Related U.S. Application Data
(60) Provisional application No. 63/467,864, filed on May 19, 2023.
(60) Provisional application No. 63/451,847, filed on Mar. 13, 2023.

(51) Int. Cl. F03D 13/25; B63B 35/44; B63B 39/02; B63B 39/06; B63B 79/10; B63B 79/40; F03D 13/20

(52) U.S. Cl. CPC F03D 13/256; B63B 35/44; B63B 39/02; B63B 39/06; B63B 79/10; B63B 79/40; F03D 13/201; B63B 2035/446; F05B 2240/93; F05B 2240/95

(57) ABSTRACT

A floating wind power platform is suitable for offshore deployment in deep-sea environments. The platform includes a tower that supports a wind turbine and a base support structure that is stabilized by a combination of stabilizers, struts, and floats. The platform furthermore includes a set of propellers and an electronic motion control system to control position and orientation relative to the wind. The floating wind power platform may be deployed in groups of connected platforms tethered to a centralized fuel production platform, carbon dioxide (CO2) capture and sequestration platform, or other processing platform that transforms and/or utilizes energy captured from the wind power platforms.

### CROSS-REFERENCE TO RELATED APPLICATIONS

This application claims the benefit of U.S. Provisional Application No. 63/451,847 filed on Mar. 13, 2023 and U.S. Provisional Application No. 63/467,864 filed on May 19, 2023, the contents of which are incorporated by reference herein.

### BACKGROUND

### 1. Technical Field

This disclosure relates to a wind power generation platform for offshore deployment.

### 2. Description of the Related Art

Land-based wind turbine technology has developed rapidly and represents an important component of the world's energy production system. However, a very large fraction of the wind energy near the Earth's surface is found in deep ocean regions which are far offshore. Significant challenges with offshore deployment exist, such as maintaining stability of the platform against wind, waves, and transient acceleration forces of the wind turbine. Furthermore, challenges exist in harnessing and effectively utilizing the power produced by offshore wind generation platforms.

### BRIEF DESCRIPTION OF THE DRAWINGS

FIG. 1A is a first view of an example embodiment of a floating wind power platform.

FIG. 1B is a second view of an example embodiment of a floating wind power platform.

FIG. 1C is a third view of an example embodiment of a floating wind power platform.

FIG. 1D is a fourth view of an example embodiment of a floating wind power platform.

FIG. 1E is a fifth view of an example embodiment of a floating wind power platform.

FIG. 1F is a sixth view of an example embodiment of a floating wind power platform.

FIG. 2A is a first view of an embodiment of a floating wind power platform with an optional diagonal strut.

FIG. 2B is a first example embodiment of a diagonal strut for a floating wind power platform.

FIG. 2C is a second example embodiment of a diagonal strut for a floating wind power platform.

FIG. 2D is a third example embodiment of a diagonal strut for a floating wind power platform.

FIG. 3 is another example embodiment of a floating wind power platform that includes lateral thrusters.

FIG. 4A is a first view of an example embodiment of a moored floating wind power platform.

FIG. 4B is a second view of an example embodiment of a moored floating wind power platform.

FIG. 4C is a third view of an example embodiment of a moored floating wind power platform.

FIG. 4D is a fourth view of an example embodiment of a moored floating wind power platform.

FIG. 4E is a fifth view of an example embodiment of a moored floating wind power platform.

FIG. 4F is a sixth view of an example embodiment of a moored floating wind power platform.

FIG. 5 is an embodiment of a moored floating wind power platform with diagonal struts.

FIG. 6A is first view of a floating energy system.

FIG. 6B is a second view of a floating energy system.

FIG. 7 is an example embodiment of a floating energy-to-fuel platform.

FIG. 8 is an example embodiment of a floating carbon dioxide (CO2) capture and sequestration platform.

### DETAILED DESCRIPTION

A floating wind power platform generates clean power from wind energy and provides high stability for offshore deployment. The platform includes a tower that supports a wind turbine and a floating base that is stabilized by a combination of stabilizers, struts, and floats. The platform furthermore optionally includes a set of propellers and an electronic motion control system to control position and orientation relative to the wind. Embodiments of the floating wind power platform may include a free-floating platform which includes said propellers and motion control system that is stable offshore without any tethering or anchoring, or a moored platform suitable for deployment in shallower offshore locations. In different configurations, a set of multiple floating wind power platforms may be tethered to a centralized fuel production platform, carbon dioxide (CO2) capture and sequestration platform, or other processing platform that transforms and/or utilizes energy captured from the wind power platforms.

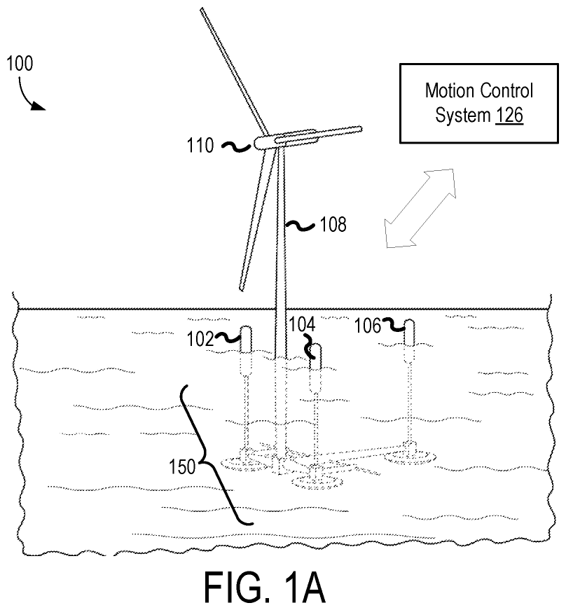

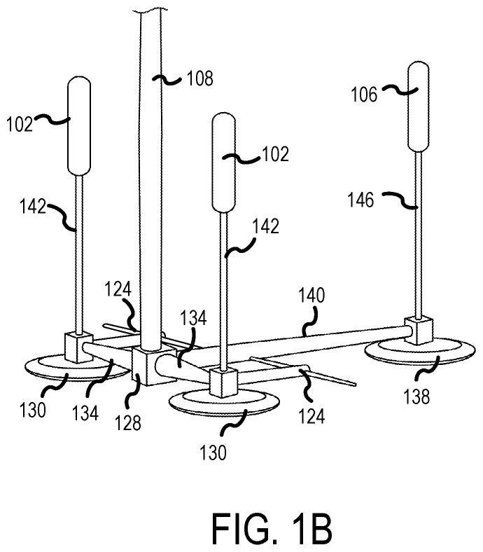

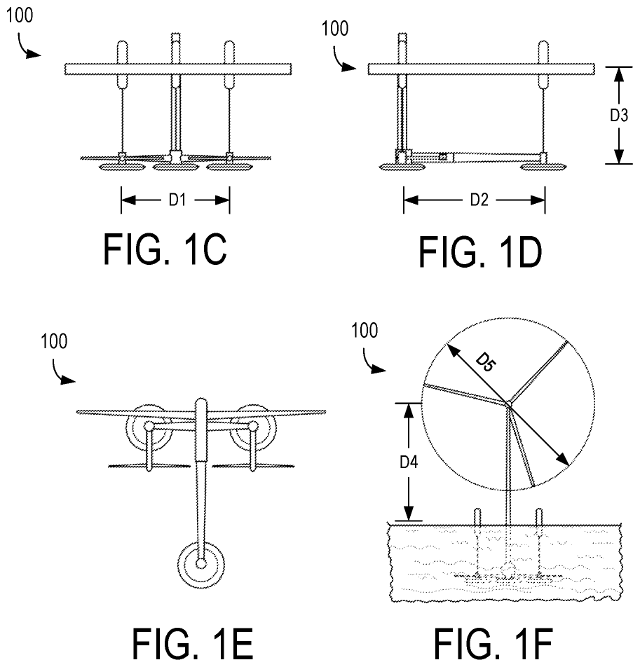

FIGS. 1A-1F illustrate different views of an example embodiment of a free floating wind power platform 100. FIG. 1A illustrates a full perspective view of the free floating wind power platform 100. FIG. 1B illustrates a zoomed in view of a base support structure 150 for the free floating wind power platform 100. FIG. 1C-1F illustrate additional various views of the free floating wind power platform 100 and example dimensions.

The free floating wind power platform 100 includes at least a base support structure 150, a set of forward floats 102 and at least one aft float 106, a tower 108, a wind turbine 110 attached to the tower 108. The floating wind power platform 100 may furthermore include a motion control system 126 and a set of propellers 124. When deployed, the base support structure 150 is submerged deep under the sea surface. The tower 108 rises from the base support structure 150 to a height above the sea surface sufficient to support the wind turbine 110 at or near the top of the tower 108.

In an example implementation, the base support structure 128 includes a tower base support 128, a pair of forward stabilizers 130, a pair of forward struts 134 coupled between the pair of forward stabilizers 130 and the tower base support 128, an aft stabilize 138, and an aft strut 140 coupled between the aft stabilizer 138 and the tower base support 128. The forward struts 134 may extend laterally in opposite directions from tower base support 128 to provide lateral stability. The aft strut 140 extends from the tower base support 128 substantially perpendicular to the forward struts 134 (e.g., within a reasonable tolerance such as 1%, 2%, 5%, 10%, etc.).

In some embodiments, the wind turbine 110 may have fixed orientation relative to the base support structure 150. Here, the forward struts 134 extend perpendicular to the axis of rotation of the wind turbine 110 while the aft strut 140 extends parallel to the axis of rotation of the wind turbine 110. In this manner, the forward struts 134 and forward stabilizers 130 provide lateral support (perpendicular to the axis of rotation of the wind turbine 110), and the aft strut 140 and aft stabilizer 138 provide support along the axis of rotation of the wind turbine 110. In other embodiments, the wind turbine 110 may rotate independently of the base support structure 128.

The forward struts 134 and the aft strut 140 may each comprise steel reinforced post-tensioned concrete tubes. In this structure, the struts 134, 140 contribute significant buoyancy to the floating wind power platform 100. The struts 134, 140 may be tubular to enable personnel access to the underwater propellers 124 or other submerged components (e.g., through a hatch in the tower above the water line).

The stabilizers 130, 138 provide mass that operates in conjunction with the floats 102, 106 to provide vertical (heave) dynamic stabilization by opposing the heave forces from passing waves. The floats 102, 106 together with the mass (which may include the stabilizers 130, 138, added mass from seawater, struts 134, 140, and other components of the base support 150) may be modeled as a damping mechanical resonator system. In one embodiment, the stabilizers 130, 138 may comprise round or square plates such as disk or disk-like solid masses. The primary surfaces of the stabilizers 130, 138 are oriented horizontally (substantially perpendicular to the tower 108) to resist motion relative to sea water above and below the stabilizers 130, 138. The sea water above and below the stabilizers 130, 138 acts as added mass in the damping mechanical resonator model and contributes to the effective stability of the floating wind power platform 100. In another embodiment, the stabilizers 130, 138 may comprise hollow disks, spheres, or other volumes that entrain seawater when deployed. The stabilizers 130, 138 may be nominally neutrally buoyant when submerged and therefore exert relatively little force on the struts 134, 140 when the ocean is calm (little to no waves).

The floats 102, 106 may include a pair of forward floats 102 coupled to the respective forward stabilizers 130, and an aft float 106 coupled to the aft stabilizer 138. The floats 102, 106 may couple to the stabilizers 130, 138 via respective forward and rear tension members 142, 146 (e.g., cables) that may be coupled to the stabilizers 130, 138 using flexible joints (e.g., swivel joints). The flexible joints enable lateral motion of the floats 102, 106 relative to the stabilizers 130, 138. Thus, the floats 102, 106 can absorb motion from passing waves, without passing significant lateral force to the stabilizers 130, 138. The floats 102, 106 may be constructed of post-tensioned concrete, steel, Styrofoam, fiberglass, or other suitable material.

The propellers 124 produce kinetic forces for changing position and/or orientation of the floating wind power platform 100. In an embodiment, a pair of propellers 124 may be aft-facing and coupled behind each of the forward stabilizer 130. In other configurations, the floating wind power platform 100 may include a different number of propellers 124 and/or propellers 124 may be differently positioned. For example, in other variations, there may be more than two propellers 124, such as four or six, each of which may have a smaller diameter, and with an equal number of propellers 124 on each side of the tower 108.

The propellers 124 may operate in conjunction with an electronic motion control system 126 that controls operation of the propellers 124. The motion control system may include various inertial and/or positional sensors (e.g., GPS system sensors, accelerometers, gyroscopes, magnetometers, etc.) that sense position and/or orientation of the floating wind power platform 100. The sensors may furthermore sense wind direction and/or magnitude, wave direction and/or magnitude, or other environmental conditions. The motion control system 126 includes various control electronics, actuators, and/or other drive components to controls the propellers 124 to achieve a target motion or maintain a static position and/or orientation.

In an embodiment, the motion control system 126 may sense a predominant wind direction and drive the propellers 124 to maintain an orientation of the floating wind power platform 100 such that the wind turbine 110 faces into the wind (i.e., the axis of rotation corresponds to the wind direction), or otherwise achieves an orientation optimized for capturing wind energy. Based on motion and/or positional sensor data, the motion control system 126 may furthermore control the propellers 124 such that the floating wind power platform 100 maintains a substantially stationary position Alternatively, the motion control system 126 may allow the platform 100 to float freely within a defined geofenced region. Here, the motion control system 126 may drive the propellers 124 to maintain orientation relative to the wind and keep the position within the geofenced region. In further embodiments, the motion control system 126 may actively drive the propellers 124 to navigate the floating wind power platform 100 between geographic position. For example, the motion control system 126 may navigate the floating wind power platform 100 from an initial deployment location (which may be close to shore) to an operational position that may be 1000s of kilometers from the deployment location. Furthermore, the motion control system 126 may actively navigate the floating wind power platform 100 between operating positions, e.g., to avoid tropical storms or other weather events, or to find locations with higher wind energy.

The motion control system 126 may include various electronics that may be internally located anywhere in the floating wind power platform 100 (e.g., within the tower 108, struts 134, 140, or tower base support 128) or externally attached to the floating wind power platform 100. Furthermore, the motion control system 126 may include various components that are distributed at different locations within the floating wind power platform 100. In some embodiments, all or parts of the motion control system 126 may be located remotely from the floating wind power platform 100 and communicatively coupled to the floating wind power platform 100 via wired or wireless communication mechanisms.

The tower 108 extends from the underwater tower base support 128 to a height above the sea surface. The tower 108 may comprise a tubular structure to enable personnel access. In an embodiment, the tower 108 may be constructed from post-tensioned concrete. Alternatively, the tower 108 may be constructed from steel and/or various other materials. The tower 108 is of sufficient height to support the wind turbine 110 entirely above sea level.

The wind turbine 110 comprises a rotor, a set of blades, and various supporting components for converting wind energy into electricity. Under typical operating conditions, the wind turbine 110 is pointed into the wind such that a set of aerodynamic blades rotate around a horizontal axis parallel to the wind direction. The blades are connected to a hub, which in turn is linked to a gearbox or direct-drive system located within a turbine nacelle. The nacelle houses components such as a generator, gearbox, control systems, and other electronics necessary for power conversion and monitoring. As the wind turns the rotor blades, the kinetic energy is transferred to the generator, where it is converted into electrical power for distribution to the grid or for local use. The wind turbine 110 may furthermore include various yaw and pitch control mechanisms to orient the rotor into the direction of the prevailing wind and optimize energy capture.

The above-described floating wind power platform 100 may be constructed in a wide variety of different scales and relative dimensions. For example, in one embodiment, the floating wind power platform 100 may be dimensioned such that the base support structure 150 is submerged at a depth of approximately 80 meters (D₃ in FIG. 1D) below the sea surface when deployed and the tower 108 extends above the sea surface 160 to a height of approximately 170 meters (D₄ in FIG. 1F) (i.e., the total tower length may be approximately 250 meters). In other variations, the base support structure 150 may be submerged at a depth anywhere in the range of 40-120 meters below the sea surface 160 and the tower 108 may extend to a height in the range of 100-250 meters above the sea surface 160 (i.e., the total tower length may be in the range of 140-370 meters). The blades of the wind turbine 110 may have a total diameter of approximately 240 meters (D₅ in FIG. 1F). In other variations the wind turbine blades may have a collective diameter in the range of 200-300 meters. The forward struts 134 support respective forward stabilizers 130 with a lateral distance of approximately 90 meters (D₁ in FIG. 1C) between centroids of the stabilizers 130. The aft strut 140 may have a length longer than the distance between the forward stabilizers 130. For example, the aft strut 140 may have a length of approximately 120 meters (D₂ in FIG. 1D). In other variations, the forward struts 134 may be structured to support the forward stabilizers 130 with a distance between 70-150 meters between their respective centroids, and the aft strut 140 may have a length between 80-200 meters. The struts 134, 140 may have respective diameters of approximately 8 meters. In other variations, the struts 134, 140 may have diameters in the range of 6-15 meters. The stabilizers 130, 138 may each have a diameter of approximately 40 meters and a height of approximately 5 meters. In other variations, the stabilizers 130, 138 may have respective diameters in the range of 30-50 meters and heights in the range of 2-10 meters. The underwater aft-thrusting propellers of 124 may each have diameter of approximately 70 meters. In other variations, the propellers 124 may have diameters in the range of 50-90 meters. In yet further embodiments, the floating wind power platform 100 may have different dimensions outside of the example ranges provided above.

The base support structure 150 together with the floats 102, 106 operate to provide hydrodynamic resistance to vertical movement. The floating wind power platform 100 beneficially has multiple stabilization points where vertical motion (heave) is resisted by the combination of a deep structurally coupled mass (e.g., the stabilizers 130, 138 and added mass from the seawater) and buoyant elements (such as vertically extended floats 102, 106). The structure may be designed such that the resonant frequency (when modeled as a damped resonator) is less than the period of typical ocean waves, thus avoiding significant resonance with the wave frequencies.

The floating wind power platform 100 provides sufficient stability to substantially maintain its relative position and maintain stability even through transient accelerations of the wind turbine 110. For example, each of the stabilizers 130, 138 extends deeply enough that their mass is not significantly disturbed by wave motion. The tension members 142, 146 between the stabilizers 130, 138 and the floats 102, 106 furthermore can be sufficiently flexible to enable the floats 102, 106 to move laterally as waves pass, without causing significant vertical motion. Thus, the floating wind power platform 100 is effectively decoupled from wind and wave dynamic under a very wide range of wind and sea state conditions. In an example embodiment, the free floating wind power platform 100 may be deployed in environments having sea depth greater than a few hundred meters.

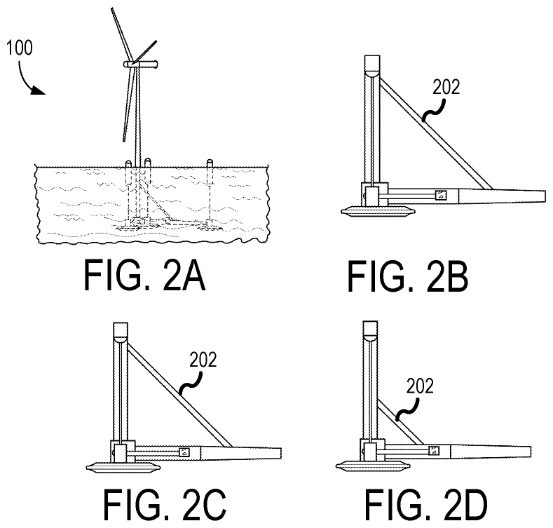

FIGS. 2A-D illustrate an embodiment of a floating wind power platform 100 with an optional diagonal strut 202 connecting between the tower 108 and the aft strut 140. The diagonal strut 202 reduces the peak bending moments and stresses on the structure. In an embodiment, the diagonal strut 202 may form approximately 45 degree angles with respect to the tower 108 and aft strut 140. The diagonal strut can be of various lengths and may connect to the tower 108 at different heights and/or different positions along the length of the aft strut 140 as shown in FIGS. 2B-D. The diagonal strut 202 may be constructed of post-tensioned concrete or other suitable material similar to other struts 134, 140 described herein.

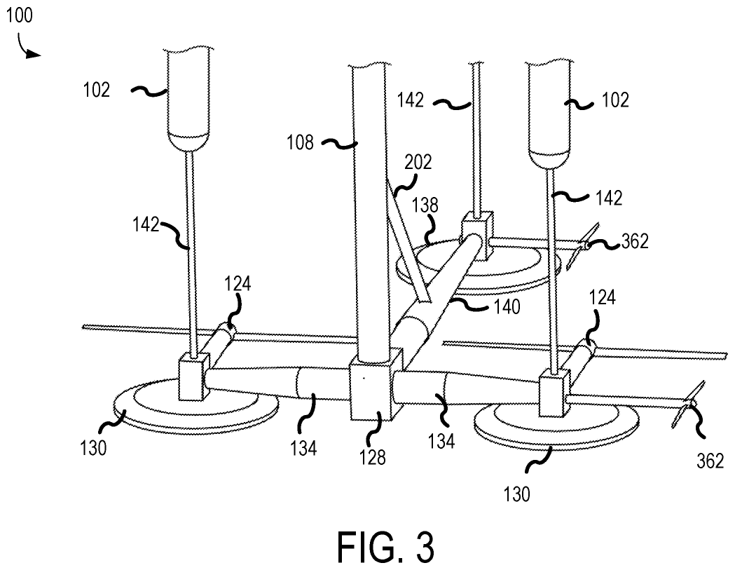

FIG. 3 illustrates another example embodiment of a free floating wind power platform 100. In this embodiment, the propellers 124 may include a combination of the aft-facing propellers 124 described above and a set of laterally facing propellers (“thrusters”) 362 mounted in fore and aft positions on either side of the tower 108. These thrusters 362 may be controlled to maintain position in the presence of water flow (current) in the lateral direction, and/or may be used when one or more of the aft-facing propellers 124 is not functioning to counter the resulting torque on the free floating wind power platform 100. These lateral thrusters 362 may be smaller and lower power than the aft-thrusting propellers 124.

FIG. 3 illustrates the free floating wind power platform 100 with the optional diagonal strut 202 described above. In alternative embodiments, the floating wind power platform 100 may include the lateral thrusters 362 without necessarily including the diagonal strut 202.

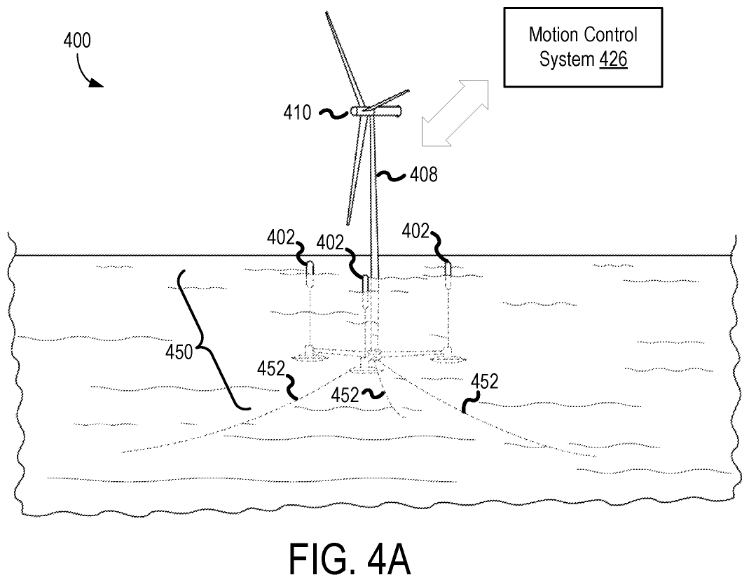

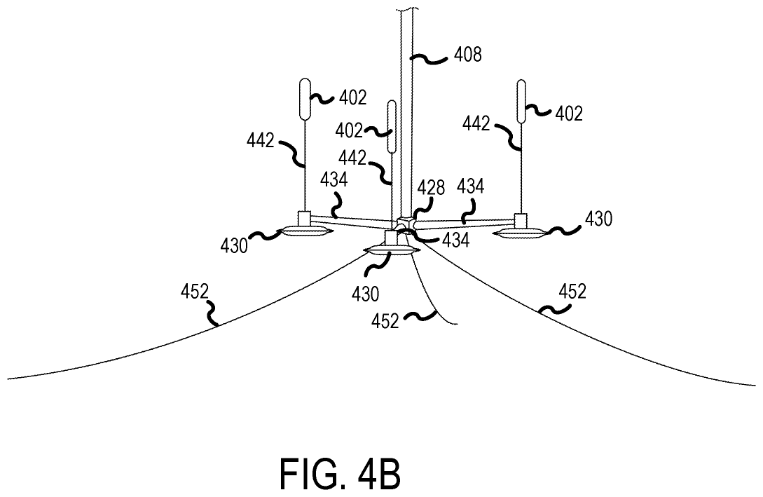

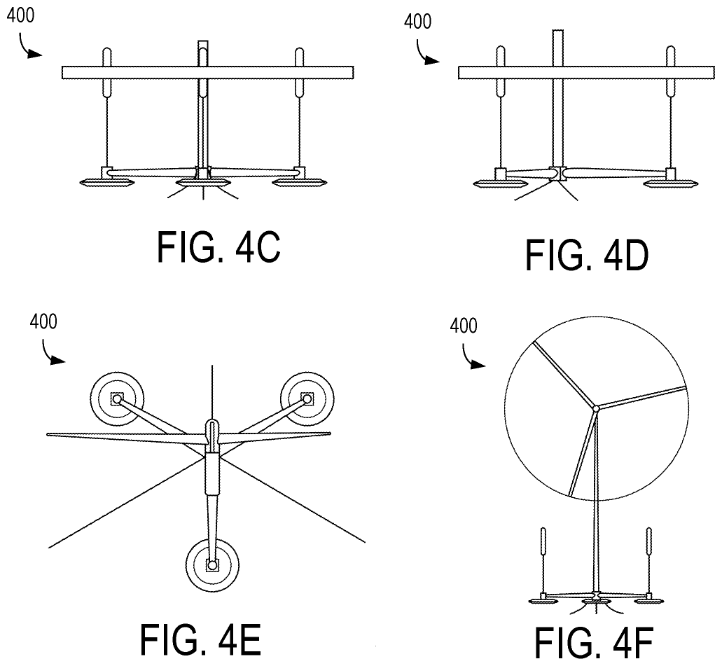

FIGS. 4A-F illustrate various views of an example embodiment of a moored floating wind power platform 400. The moored floating wind power platform 400 includes a base support structure 450 submerged underwater, a set of floats 402, and a tower 408 that extends from the base support structure 450 and supports a wind turbine 410 above sea level. The struts 434 couple between a tower base support 428 and respective stabilizers 430. The stabilizers 430 couple to the respective floats 402 via respective tension members 442. Mooring lines (e.g., cables) 452 attach to the base support structure 450 and are anchored to the ocean floor. In the illustrated example, three mooring lines 452 attach to the base support structure 450 (e.g., at the tower base support 428). Alternatively, a different number of mooring lines 452 may be used and/or the mooring lines 452 may attach to different points on the base support structure 450. In an example embodiment, the moored floating wind power platform 400 may operate in water depths ranging from 100 to 1000 meters.

An embodiment of the moored floating wind power platform 400 includes three struts 434 extending at approximately equally spaced angles (e.g., approximately 120 degrees apart) from the tower base support 428. The struts 434 may be of equivalent length in this embodiment (e.g., 80 meters or in the range of 50-120 meters). The mooring lines 452 may extend at angles halfway between each pair of adjacent struts 434. In other embodiments, adjacent struts 434 may have relative angles between 100 to 150 degrees and are not necessary equally spaced. Furthermore, in other embodiments, the moored floating wind power platform 400 may include a different number of struts 434, floats 402, and stabilizers 430. Other dimensions of the moored floating wind power platform 400 may be similar to those of the free-floating wind platform 100 described above.

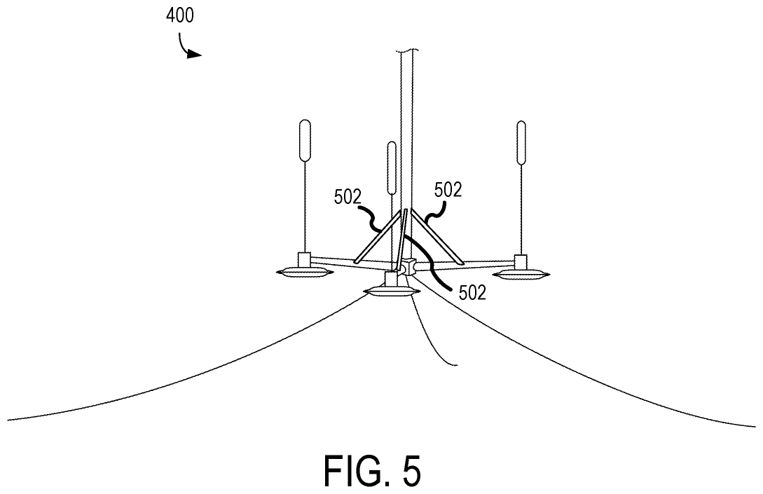

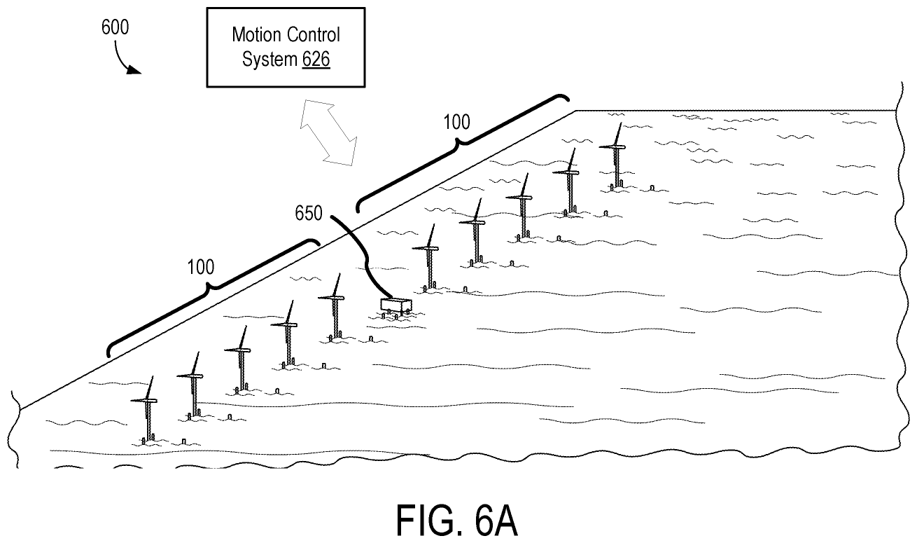

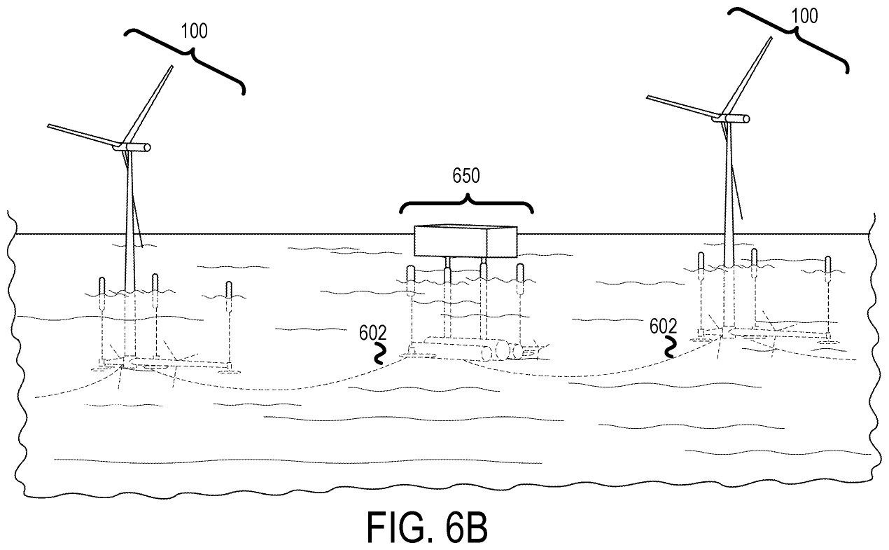

The moored floating wind power platform 400 may optionally include diagonal struts 502 between the tower 408 and each of the bottom struts 434 as shown in FIG. 5. The diagonal struts 502 may be structured similarly to those shown in any of FIGS. 2A-D. These diagonal struts 502 reduce the peak bending moments and stresses on the structure.

The moored floating wind power platform 400 may optionally omit the propellers 124 and the orientation of the moored base support structure 450 may remain substantially stable. A motion control system 426 for the moored floating wind power platform 400 may instead rotate orientation of the wind turbine 410 (either the turbine 410 alone or the tower 408) relative to the moored base support structure 450 to orient the wind turbine 110 into the wind.

FIGS. 6A-6B illustrate an example embodiment of a floating energy platform 600 that includes multiple floating wind power platforms 100 and at least one processing platform 650. In an embodiment, the floating wind power platforms 100 and processing platform 650 are arranged in a row and coupled by underwater power cables 602 for supplying electricity generated by the floating wind power platforms 100 to the processing platform 650. The illustrated example shows the processing platform 650 in a central position (e.g., flanked by an equal number of floating wind power platforms 100 per side). Alternatively, the processing platform 650 may be connected in a different position.

Motion of the floating energy platform 600 may be actively controlled through a motion control system 626 to maintain position and/orientation of the floating wind power platforms 100 and the processing platform 650 relative to each other and/or relative to the wind direction. For example, the floating wind power platforms 100 and processing platform 650 may rotate in a line such that each floating wind power platform 100 is appropriately oriented into the wind. Furthermore, the motion control platform 626 may provide position control for the floating energy platform 600 to navigate the floating energy platform 600 to an operating position.

In an embodiment, the motion control system 626 provides direct centralized control of the respective propellers 124 of each of the floating wind power platforms 100 and the processing platform 650. In another embodiment, the motion control system 626 comprises a distributed control system with each platform 100, 650 locally controlling its position and/or orientation. In yet another embodiment, the motion control system 626 may provide centralized coordination between local motion control systems for each platform 100, 650.

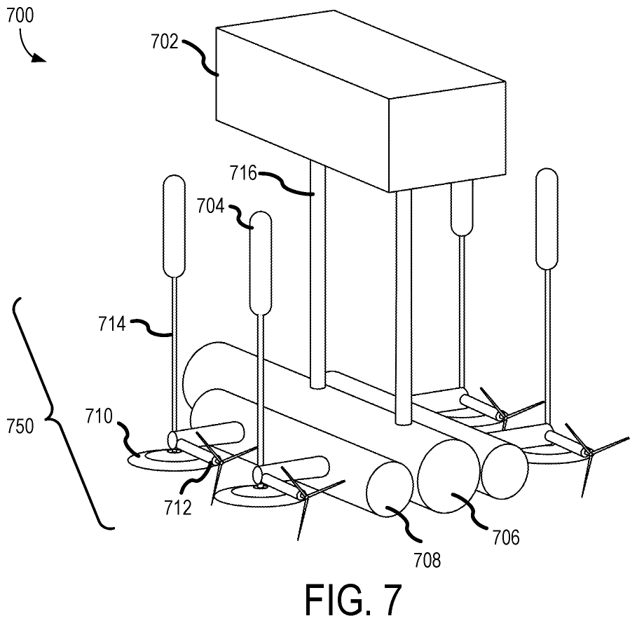

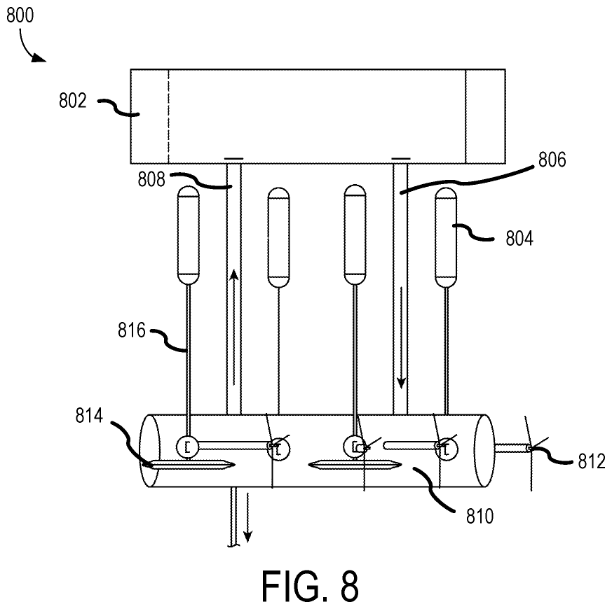

In one example embodiment, the processing platform 650 may comprise a power-to-fuel platform that converts electricity generated from the floating wind power platforms 100 to fuel (as described in FIG. 7 below) In another embodiment, the processing platform 650 may comprise a CO2 capture and sequestration platform (as described in FIG. 8 below). In further embodiments, the floating energy platform 600 may include more than one processing platform 650 of the same or different type.

In further embodiments, the floating energy platform 600 described herein may include one or more moored floating wind power platforms 400 instead of the free floating wind power platforms 100. In this embodiment, the motion control platform 626 may be optionally omitted.

FIG. 7 illustrates an example embodiment of a power-to-fuel platform 700 that may be utilized as the processing platform 650 in the configuration of FIGS. 6A-B. The power-to-fuel platform 700 includes process equipment supported by an above water equipment platform 702, a set of floats 704, one or more towers 716 supporting the equipment platform 702, and an underwater base structure 750 including a fuel storage tank 706, one or more air/ballast tanks 708, a set of stabilizers 710, and a set of propellers 712.

In the illustrated structure, a centralized fuel storage tank 706 includes two towers 716 that support the process equipment platform 702. The towers 716 may include transport tubes for transporting fuel generated by the process equipment to the fuel tank 706 for storage. The fuel storage tank 706 may be flanked on both sides by a set of air/ballast tanks 708. The fuel storage tank 706 and air/ballast tanks 708 may each comprise substantially cylindrical tanks, which may be oriented horizontally in the water. The fuel storage tank 706 and air/ballast tanks 708 may be constructed of steel-reinforced post-tensioned concrete or other suitable materials.

A set of stabilizers 710 attach to each of the air/ballast tanks 708 to provide additional lateral support. The stabilizers 710 may have a disk or disk-like form factor structured similarly to the stabilizers 130, 138 used in the floating wind power platform 100 described above. Each of the stabilizers 710 may be coupled to a respective float 704 via a flexible tension member 714 (e.g., a cable), similar to the floating wind power platform 100 described above. The stabilizers 710 and respective floats 704, when modeled as damped resonator, may have a resonant frequency which is less than half the normal minimum frequency of waves where the system is positioned. The propellers 712 operate in response to control signals from a motion controller (which may be a local motion controller, a centralized motion controller, or a combination thereof) to control position and/or orientation of the power-to-fuel platform 700 relative to the wind and/or wave direction.

In the illustrated example structure, the floating power-to-fuel platform 700 includes four stabilizers 710 and four floats 704 coupled by respective tension members 714 (e.g., arranged in approximate corners of a rectangle near the outside of the floating power-to-fuel platform 700. For example, two stabilizers 710 may attach to the exteriors of respective air/ballast tanks 708 on each side of the fuel tank 706. A set of four propellers 712 couple to the respective stabilizers 710. In alternative embodiments, the floating power-to-fuel platform 700 may have different arrangements of propellers 712, which may include a combination of aft-facing propellers 712 as shown and optional lateral thrusters similar to those described above with respect to the free floating wind power platform 100.

In one embodiment, the power-to-fuel platform 700 produces and stores liquid organic hydrogen carriers that serve as a hydrogen-based (e.g., H₂) energy source. Suitable liquid organic hydrogen carriers are composed of unsaturated aromatics, such as benzene/cyclohexane and toluene/methyl cyclohexane, which can be hydrogenated and dehydrogenated reversibly without destroying the main structure of the carbon ring. Such components are transportation-friendly and low toxicity, which makes them suitable for storage and utilization. In this example, liquid toluene may be shipped to the energy platform and stored for conversion in a holding tank on the equipment platform above sea level. Electrical power from the floating wind power platforms 100 is then used to electrolyze seawater and generate hydrogen, which is applied to convert the toluene to methylcyclohexane. This hydrogenated product is then stored underwater in the fuel storage tank 706 for later collection and shipping to shore where it may be dehydrogenated. The resulting hydrogen can be fed into a protonic fuel cell to directly generate DC power that can be converted and fed into the electrical grid. In other embodiments, the power-to-fuel platform 700 may utilize Fischer-Tropsch chemistry and a Sabatier process for fuel production. In further embodiments, the power-to-fuel platform 700 may include process equipment for producing ammonia. In yet further embodiments, the power-to-fuel platform 700 may include process equipment for methanol or various hydrocarbons that may be produced based on CO2 capture techniques.

In alternative embodiments, a moored power-to-fuel platform 700 may include mooring lines 452 to tether the power-to-fuel platform 700 to the ocean floor and may optionally omit the propellers 712 and electronic motion control system 626.

FIG. 8 illustrates an example embodiment of a CO2 capture and sequestration platform 800 that may be utilized as the processing platform 650 in the floating energy platform 600 described above with respect to FIGS. 6A-B. In this embodiment, the CO2 capture and sequestration platform 800 operates to separate CO2 from seawater and/or the air using power generated from the floating wind power platforms 100.

In an example embodiment, the CO2 capture and sequestration platform 800 comprises an equipment platform 802, a set of floats 804, a set of vertical pipes 806, 808, a flow chamber 810, a set of stabilizers 814, and a set of propellers 812. The floats 804 and stabilizers 814 may be coupled by tension members 816 similar to the other platforms 100, 700 described herein. The propellers 812 may be controlled similar to the other platforms 100, 700 described herein to control position and/or orientation of the CO2 capture and sequestration platform 800. For example, the CO2 capture and sequestration platform 800 may have different arrangements of propellers 812, which may include a combination of aft-facing propellers 812 as shown and optional lateral thrusters similar to those described above with respect to the free floating wind power platform 100.

The CO2 capture and sequestration platform 800 may pump sea water through one of the vertical pipes 808 for processing by the processing equipment in the equipment platform 802. The processing equipment operates to separate CO2 from the seawater using power from the floating wind power platforms 100. For example, the CO2 capture and sequestration platform 800 may capture seawater as it flows through the flow chamber 810 and pump the sea water to the surface equipment platform 802 for processing. Alternatively, the equipment platform 802 may extract CO2 from the air. The CO2 capture and sequestration platform 800 pressurizes the CO2 and transports the pressurized CO2 via a vertical pipe 806 to a sufficient depth below sea level at which the pressurized CO2 liquifies and is pumped under the sea floor sediment, where it becomes stable due its density and the formation of CO2 hydrates. Alternatively, the CO2 capture and sequestration platform 800 may operate to facilitate reactions of the liquid CO2 with seawater to form stable hydrates. Hydrate formation may be enhanced by active injection of ocean water into the pipe 806 before the liquid CO2 exits.

In alternative embodiments, a moored CO2 capture and sequestration platform 800 may include mooring lines 452 to tether the CO2 capture and sequestration platform 800 to the ocean floor and may optionally omit the propellers 812 and electronic motion control system 626.

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope is not limited by this detailed description, but rather by any claims that issue on an application based hereon. Accordingly, the disclosure of the embodiments is intended to be illustrative, but not limiting, of the scope of the invention, which is set forth in the following claims.

1. A floating wind power platform for deep sea deployment, comprising:
a base support structure comprising:
a tower base support;
a pair of forward stabilizers;
a pair of forward struts coupled between the pair of forward stabilizers and the tower base support;
an aft stabilizer;
an aft strut coupled between aft stabilizer and the tower base support;
a set of floats comprising:
a pair of forward floats respectively coupled to the pair of forward stabilizers via respective forward tension members;
an aft float coupled to the aft stabilizer via an aft tension member;
a tower extending from the tower base support; and
a wind turbine attached to the tower.

2. The floating wind power platform of claim 1, wherein the aft strut extends substantially parallel to an axis rotation of the wind turbine.

3. The floating wind power platform of claim 2, wherein the pair of forward struts extend in substantially opposite lateral directions from the tower base support and are substantially perpendicular to the aft strut.

4. The floating wind power platform of claim 1, wherein the pair of forward stabilizers and the aft stabilizer comprise drag plates that interact with surrounding sea water to provide stabilization.

5. The floating wind power platform of claim 1,
wherein the pair of forward tension members couple to the pair of forward stabilizers via respective forward flexible joints that enable lateral motion of the pair of forward floats relative to the pair of forward stabilizers, and
wherein the aft tension member couples to the aft stabilizer via an aft flexible joint that enables lateral motion of aft float relative to the aft stabilizer.

6. The floating wind power platform of claim 1, further comprising:
an orientation control system to sense an orientation of the wind turbine relative to a wind direction and orient the floating wind power platform such that the wind turbine is directed into the wind direction.

7. The floating wind power platform of claim 6, wherein the orientation control system comprises:
one or more sensors to generate sensor data indicative of the wind direction;
one or more propellers; and
control electronics to control the one or more propellers based on the sensor data.

8. The floating wind power platform of claim 7, wherein the one or more propellers comprises:
a pair of aft-facing propellers positioned laterally on either side of the tower.

9. The floating wind power platform of claim 7, wherein the one or more propellers further comprises:
a pair of lateral thrusters on fore and aft sides of the tower, the lateral thrusters controlled by the control electronics to resist lateral currents and to provide torque to counter torque of a non-operational aft-facing propeller.

10. The floating wind power platform of claim 1, further comprising:
a diagonal support coupled between the tower and the aft strut.

11. The floating wind power platform of claim 1, wherein at least one of the pair of forward struts, the aft strut, and the tower comprise post-tensioned concrete.

12. The floating wind power platform of claim 1, wherein at least one of the pair of forward struts, the aft strut, and the tower comprise tubular structures.

13. The floating wind power platform of claim 1, wherein the floating wind power platform is configured to be deployed in an unmoored free floating environment.

14. The floating wind power platform of claim 1, wherein the pair of forward floats and the aft float are configured to float at sea level surface, wherein the forward stabilizers, the aft stabilizer, the pair of forward struts, and the aft strut are submerged at a depth between 40-120 meters below the sea level surface, and wherein the wind turbine is attached to the tower at a height between 100-250 meters above the sea level surface.

15. The floating wind power platform of claim 1, wherein the pair of forward stabilizers and the aft stabilizer each comprise disks having diameters between 30-50 meters and heights between 2-10 meters.

16. The floating wind power platform of claim 1, wherein a distance between centroids of the forward stabilizers is between 70-150 meters.

17. The floating wind power platform of claim 1, wherein a length of the aft strut is between 80-200 meters.

18. The floating wind power platform of claim 1, wherein the wind turbine has a diameter between 200-300 meters.

19. (canceled)

20. A moored floating wind power platform, comprising:
a base support structure comprising:
a tower base support;
a set of stabilizers;
a set of bottom struts coupled between the set of stabilizers and the tower base support;
a set of floats respectively coupled to the set of stabilizers via respective tension members;
a tower extending from the tower base support;
a wind turbine attached to the tower; and
a set of mooring lines for coupling the base support structure to a sea floor.

21-22. (canceled)

23. A floating energy system comprising:
a plurality of floating wind power platforms to generate electricity from wind energy, wherein each of the floating wind power platforms comprises:
a base support structure comprising:
a turbine tower base support;
a pair of forward stabilizers;
at pair of forward struts coupled between the pair of forward stabilizers and the turbine tower base support;
an aft stabilizer;
an aft strut coupled between aft stabilizer and the turbine tower base support;
a set of wind platform floats comprising:
a pair of forward floats respectively coupled to the pair of forward stabilizers via respective forward tension members;
a rear float coupled to the aft stabilizer via an aft tension member;
a turbine tower extending from the turbine tower base support; and
a wind turbine attached to the turbine tower;
a floating processing platform that utilizes the electricity generated from the floating wind power platforms; and
a plurality of power cables coupling the plurality of floating wind power platforms to the floating processing platform.

24-32. (canceled)
